(19) United States
(12) Patent Application Publication
(10) Pub. No.: US 2006/0194141 A1
(43) Pub. Date: Aug. 31, 2006

(54) Positive resist composition and method for forming resist pattern using same

(75) Inventors: Hideo Hada, Kawasaki-shi (JP); Miwa Miyairi, Kawasaki-shi (JP); Takeshi Iwai, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Tokyo Ohka Kogyo Co., Ltd., Kanagawa-ken (JP)

(21) Appl. No.: 10/563,501

(22) PCT Filed: Jun. 30, 2004
(86) PCT No.: PCT/JP04/09620

§ 371 Date: Jan. 5, 2006

(30) Foreign Application Priority Data
Jul. 7, 2003 (JP) 2003-192895
Mar. 30, 2004 (JP) 2004-100204

(51) Int. Cl. G03C 1/76

(52) U.S. Cl. 430/270.1

(57) ABSTRACT

A resist composition is disclosed which is capable of suppressing the surface roughness that occurs within a resist pattern, either following etching or following developing, or preferably following both processes. A resist pattern is formed using a positive resist composition that includes: a resin component (A), which contains at least one structural unit (a1) containing a lactone represented by one of the general formulas (1) through (4) shown below: 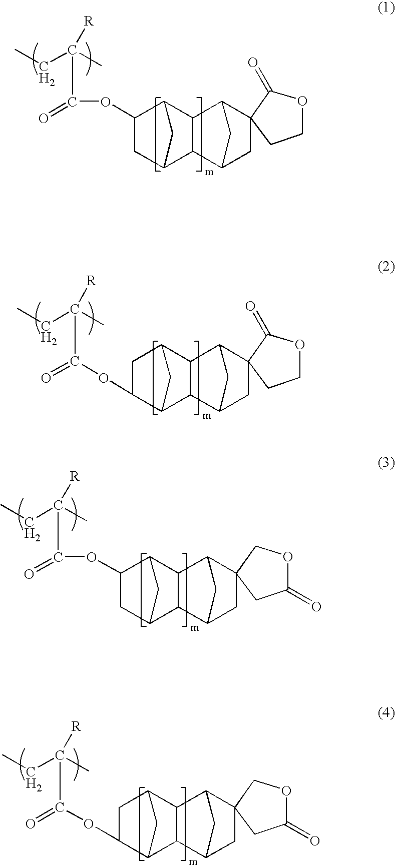 (wherein, R represents a hydrogen atom or a methyl group, and m is either 0 or 1), and exhibits increased alkali solubility under the action of acid; an acid generator component (B) that generates acid on exposure; and an organic solvent (C).

### TECHNICAL FIELD

The present invention relates to a positive resist composition, and a method for forming a resist pattern.

Priority is claimed on Japanese Patent Application No. 2003-192895, filed Jul. 7, 2003, and Japanese Patent Application No. 2004-100204, filed Mar. 30, 2004, the contents of which are incorporated herein by reference.

### BACKGROUND ART

In recent years, the miniaturization of semiconductor elements has continued to progress, and the development of processes that use ArF excimer lasers (193 nm) is being vigorously pursued. As the base resin for chemically amplified resists for use with ArF excimer lasers, resins that exhibit a high level of transparency relative to the ArF excimer laser are preferred.

For example, resins in which the principal chain contains structural units derived from a (meth)acrylate ester containing a polycyclic hydrocarbon group such as an adamantane skeleton at the ester section are attracting considerable attention, and many such resins have already been proposed (for example, see Japanese Patent (Granted) Publication No. 2,881,969, Japanese Unexamined Patent Application, First Publication No. Hei 5-346668, Japanese Unexamined Patent Application, First Publication No. Hei 7-234511, Japanese Unexamined Patent Application, First Publication No. Hei 9-73173, Japanese Unexamined Patent Application, First Publication No. Hei 9-90637, Japanese Unexamined Patent Application, First Publication No. Hei 10-161313, Japanese Unexamined Patent Application, First Publication No. Hei 10-319595, and Japanese Unexamined Patent Application, First Publication No. Hei 11-12326).

Japanese Unexamined Patent Application, First Publication No. 2003-113174 proposes compounds containing a specific lactone structure. [Patent Reference 1]

Japanese Patent (Granted) Publication No. 2,881,969

[Patent Reference 2]

Japanese Unexamined Patent Application, First Publication No. Hei 5-346668

[Patent Reference 3]

Japanese Unexamined Patent Application, First Publication No. Hei 7-234511

[Patent Reference 4]

Japanese Unexamined Patent Application, First Publication No. Hei 9-73173

[Patent Reference 5]

Japanese Unexamined Patent Application, First Publication No. Hei 9-90637

[Patent Reference 6]

Japanese Unexamined Patent Application, First Publication No. Hei 10-161313

[Patent Reference 7]

Japanese Unexamined Patent Application, First Publication No. Hei 10-319595

[Patent Reference 8]

Japanese Unexamined Patent Application, First Publication No. Hei 11-12326

[Patent Reference 9]

Japanese Unexamined Patent Application, First Publication No. Hei 2003-113174

However, in recent years, because of the development of different etching films, a variety of etching gases are now able to be used. As a result, a new problem has arisen in that surface roughness appears on the resist film following etching.

This surface roughness is different from conventional dry etching resistance, and in a film that has been etched using a resist pattern as a mask, appears as distortions around the hole patterns in a contact hole pattern, or as line edge roughness in a line and space pattern. Here, line edge roughness refers to non-uniform irregularities in the line side walls.

Furthermore, in addition to this type of surface roughness, line edge roughness also occurs in the resist pattern following developing.

If this line edge roughness occurs in the resist pattern following developing, then it appears as distortions around the hole patterns in a hole resist pattern, or as non-uniform irregularities in the side walls in a line and space pattern.

However, resist compositions using conventional resins such as those described above are unable to suppress this type of surface roughness, including line edge roughness, meaning further improvements have been keenly sought. Japanese Unexamined Patent Application, First Publication No. 2003-113174 discloses monomers that correspond with the structural unit (a1) of the present invention, but makes no mention of polymers that use such monomers, and the fact that such polymers are suitable for the purposes described above has remained unknown.

The present invention takes the above circumstances into consideration, with an object of providing a resist composition that is capable of suppressing the surface roughness that occurs within a resist pattern, either following etching or following developing, or preferably following both processes.

### DISCLOSURE OF INVENTION

A first aspect of the present invention is a polymer that includes at least one structural unit (a1) containing a lactone represented by one of the general formulas (1) through (4) shown below: 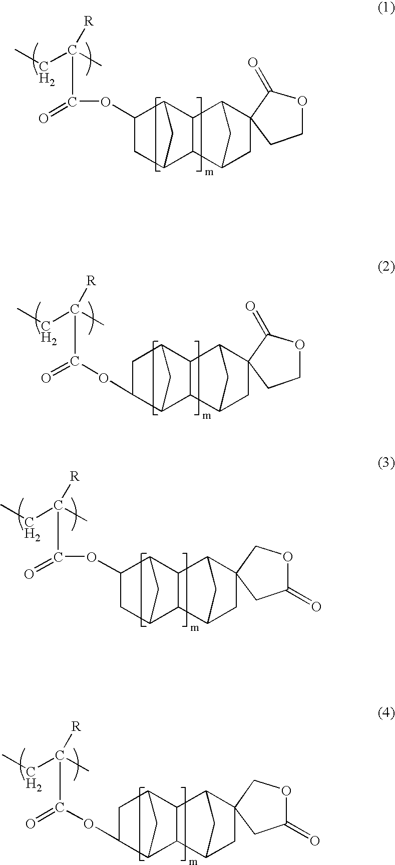
(in the formulas (1) to (4), R represents a hydrogen atom or a methyl group, and m is either 0 or 1).

A second aspect is a polymer according to the first aspect, wherein the structural unit (a1) accounts for 30 to 60 mol % of the combined total of all the structural units.

A third aspect is a polymer according to either one of the first and second aspects, further containing a structural unit (a2), which contains an acid dissociable, dissolution inhibiting group, and is derived from a (meth)acrylate ester.

A fourth aspect is a polymer according to the third aspect, wherein the structural unit (a2) is at least one unit selected from the group consisting of the general formulas (I), (II), and (III) shown below: 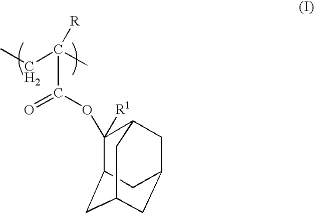
(wherein, R represents a hydrogen atom or a methyl group, and R¹ represents a lower alkyl group) 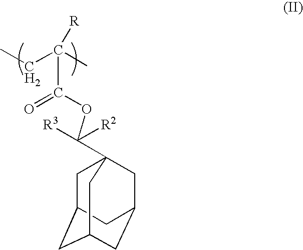
(wherein, R represents a hydrogen atom or a methyl group, and R² and R³ each represent, independently, a lower alkyl group) 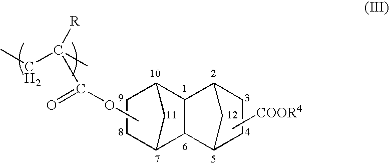
(wherein, R represents a hydrogen atom or a methyl group, and R⁴ represents a tertiary alkyl group).

A fifth aspect is a polymer according to either one of the third and fourth aspects, wherein the structural unit (a2) accounts for 20 to 60 mol % of the combined total of all the structural units.

A sixth aspect is a polymer according to any one of the first through fifth aspects, further containing a structural unit (a3), which contains a hydroxyl group and is derived from a (meth)acrylate ester.

A seventh aspect is a polymer according to the sixth aspect, wherein the structural unit (a3) is one or two units selected from the group consisting of the general formulas (IV) and (V) shown below: 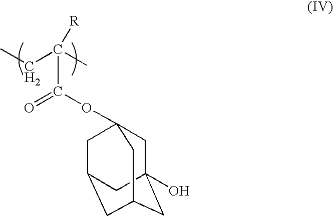
(wherein, R represents a hydrogen atom or a methyl group) 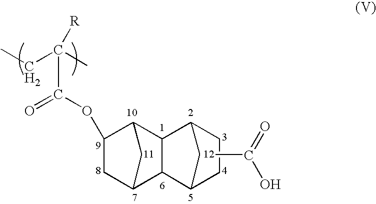
(wherein, R represents a hydrogen atom or a methyl group).

An eighth aspect is a polymer according to either one of the sixth and seventh aspects, wherein the structural unit (a3) accounts for 10 to 50 mol % of the combined total of all the structural units.

A ninth aspect is a polymer of the present invention according to any one of the first through eighth aspects, wherein the polymer exhibits increased alkali solubility under the action of acid, and is used within a positive resist composition.

A tenth aspect is a positive resist composition that includes a resin component (A), an acid generator component (B) that generates acid on exposure, and an organic solvent (C), wherein the component (A) is formed from a polymer according to the ninth aspect.

An eleventh aspect is a positive resist composition according to the tenth aspect, wherein the component (B) is an onium salt with a fluorinated alkylsulfonate ion as the anion.

A twelfth aspect is a positive resist composition according to either one of the tenth and eleventh aspects, wherein the component (C) is a mixed solvent of propylene glycol monomethyl ether acetate and a polar solvent.

A thirteenth aspect is a positive resist composition according to the twelfth aspect, wherein the polar solvent is ethyl lactate.

A fourteenth aspect is a positive resist composition according to any one of the tenth through thirteenth aspects, further containing a secondary or tertiary lower aliphatic amine (D).

A fifteenth aspect is a method for forming a resist pattern, including the steps of applying a positive resist composition according to any one of the tenth through fourteenth aspects to a substrate, conducting a prebake, performing selective exposure, conducting PEB (post exposure baking), and performing alkali developing to form a resist pattern.

### BEST MODE FOR CARRYING OUT THE INVENTION

As follows is a detailed description of embodiments of the present invention, using a series of examples.

[Polymer]

Structural Unit (a1)

In the one or more structural units (a1) represented by the above general formulas (1) through (4), those cases in which the group R in the formulas is a hydrogen atom represent acrylate structural units, and those cases in which the group R is a methyl group represent methacrylate structural units.

The structural unit (a1) is deemed to include acrylate structural units and/or methacrylate structural units.

The monomer corresponding with the structural unit (a1) usually exists as a mixture of the four isomers that generate all of the structural units represented by the general formulas (1) through (4). However, the structural unit (a1) need only include one or more of the structural units represented by the general formulas (1) through (4). m may be either 0 or 1, although in terms of industrial availability, the case in which m is 0 is preferred.

In those cases where two or more structural units represented by the general formulas (1) through (4) exist within the polymer, the nature of R and the value of m within each structural unit may be either the same or different, but is usually the same.

The structural unit (a1) typically accounts for 30 to 60 mol %, and preferably from 30 to 50 mol %, of the combined total of all the structural units that constitute the polymer. By ensuring the quantity exceeds the lower limit of this range, the surface roughness suppression effect can be improved when the polymer is used in a positive resist composition. If the quantity exceeds the upper limit of the above range, then when used in a positive resist composition, the blend quantities of the other structural units such as the structural unit that imparts increased alkali solubility in the presence of acid are reduced, which may cause problems.

When a positive resist composition is formed, the lactone functional groups are effective in improving the adhesion between the resist film and the substrate, and increasing the hydrophilicity relative to the developing solution.

When used within a positive resist composition, the aforementioned polymer preferably also includes a structural unit containing an acid dissociable, dissolution inhibiting group, so that under the action of acid generated from the aforementioned component (B) on exposure, the acid dissociable, dissolution inhibiting groups dissociate, causing the entire polymer to change from an alkali-insoluble state to an alkali-soluble state. As a result, when the composition is exposed through a mask pattern during resist pattern formation, the alkali solubility of the exposed portions increases, enabling alkali developing to be conducted.

Accordingly, when used within a positive resist composition, the polymer is preferably a copolymer that also contains the type of structural unit described below.

Structural Unit (a2)

As described above, when used within a positive resist composition, the polymer preferably includes a structural unit containing an acid dissociable, dissolution inhibiting group. There are no particular restrictions on this structural unit containing the acid dissociable, dissolution inhibiting group, provided it is capable of copolymerization with the structural unit (a1) that represents the essential component of the polymer, although from the viewpoints of factors such as the copolymerizability with the structural unit (a1) and the transparency of the polymer, an aforementioned structural unit (a2) is preferred. The term (meth)acrylate ester is a generic term that includes both methacrylate ester and acrylate ester. Similarly, the term (meth)acrylic acid is a generic term including both methacrylic acid and acrylic acid.

When used in a positive resist composition, the acid dissociable, dissolution inhibiting group can use any group, without any particular restrictions, that has an alkali solubility inhibiting effect that renders the entire polymer insoluble in alkali prior to exposure, but then dissociates under the action of acid generated from the component (B) following exposure, causing the entire polymer to become alkali-soluble.

As the acid dissociable, dissolution inhibiting group, groups that form a cyclic or chain-like tertiary alkyl ester with the carboxyl group of the (meth)acrylic acid are the most widely known.

Furthermore, from the viewpoint of improving the dry etching resistance, an acid dissociable, dissolution inhibiting group that contains an aliphatic polycyclic group is preferred.

Examples of this polycyclic group include groups in which one hydrogen atom has been removed from a bicycloalkane, tricycloalkane or tetracycloalkane or the like.

Specific examples include groups in which one hydrogen atom has been removed from a polycycloalkane such as adamantane, norbomane, isobomane, tricyclodecane or tetracyclododecane.

These types of polycyclic groups can be appropriately selected from the multitude of groups proposed for polymers (resin components) for use within ArF excimer laser resist compositions.

Of these polycyclic groups, adamantyl groups, norbomyl groups and tetracyclododecanyl groups are preferred from an industrial viewpoint.

Specifically, the structural unit (a2) is preferably at least one unit selected from the groups represented by the aforementioned general formulas (I), (II), and (III).

The structural unit represented by the general formula (I) is a (meth)acrylate structural unit with a hydrocarbon group bonded through the ester linkage, and by bonding a straight-chain or a branched alkyl group to the carbon atom of the adamantyl group that is adjacent to the oxygen atom (—O—) of the ester function of the (meth)acrylate structural unit, a tertiary alkyl group is formed within the ring skeleton of the adamantyl group.

In this formula, the group R¹ is preferably a straight-chain or branched lower alkyl group of 1 to 5 carbon atoms, and specific examples include a methyl group, ethyl group, propyl group, isopropyl group, n-butyl group, isobutyl group, tert-butyl group, pentyl group, isopentyl group and neopentyl group. Of these, an alkyl group of at least 2 carbon atoms, and preferably from 2 to 5 carbon atoms is preferred, and in such cases, the acid dissociability tends to increase compared with the case in which R¹ is a methyl group. From an industrial viewpoint, a methyl group or ethyl group is preferred.

The structural unit represented by the aforementioned general formula (II), like that of the general formula (I), is a (meth)acrylate structural unit with a hydrocarbon group bonded through the ester linkage, although in this case, the carbon atom adjacent to the oxygen atom (—O—) of the ester function of the (meth)acrylate structural unit is a tertiary alkyl group, and a ring skeleton such as an adamantyl group exists within this tertiary alkyl group.

The groups R² and R³ each preferably represent, independently, a lower alkyl group of 1 to 5 carbon atoms. These types of groups tend to display a higher acid dissociability than a 2-methyl-2-adamantyl group.

Specifically, the groups R² and R³ each represent, independently, the same types of straight-chain or branched lower alkyl groups described above for R¹. Of these groups, the case in which R² and R³ are both methyl groups is preferred from an industrial viewpoint.

In the structural unit represented by the aforementioned general formula (III), the carbon atom adjacent to the oxygen atom (—O—) of a separate ester from the ester of the (meth)acrylate structural unit is a tertiary alkyl group, and the (meth)acrylate ester structural unit and this separate ester are connected via a ring skeleton such as a tetracyclododecanyl group.

In this formula, the group R⁴ represents a tertiary alkyl group such as a tert-butyl group or tert-amyl group, although the case in which R⁴ is tert-butyl group is preferred industrially.

Furthermore, the group —COOR⁴ may be bonded to either position 3 or 4 of the tetracyclododecanyl group shown in the formula, although a mixture of both isomers results, and so the bonding position cannot be further specified. Furthermore, the carboxyl group residue of the (meth)acrylate structural unit may be bonded to either position 8 or 9 of the tetracyclododecanyl group, although similarly, a mixture of both isomers results, and so the bonding position cannot be further specified.

Of the units described above, the use of structural units represented by the general formulas (I) and/or (II) is preferred, and the use of either structural units represented by both general formulas (I) and (II), or a structural unit represented by the general formula (I) is particularly desirable. If a structural unit represented by the general formula (I) is used, R¹ is preferably a methyl group or an ethyl group. If structural units of both general formulas are used, the case in which R¹ is a methyl group, and R² and R³ are both methyl groups provides superior resolution, and is consequently preferred.

The structural unit (a2) typically accounts for 20 to 60 mol %, and preferably from 20 to 50 mol %, of the combined total of all the structural units that constitute the polymer. By ensuring the quantity exceeds the lower limit of this range, a more favorable variation in polymer solubility is achieved under the action of acid when the polymer is used in a positive resist composition. If the quantity exceeds the upper limit of the above range, then there is a danger that problems may arise in terms of achieving a favorable balance with the other structural units.

Structural Unit (a3)

Because a hydroxyl group is a polar group, including the structural unit (a3) in the polymer improves the affinity between the entire polymer and the alkali developing solution used during formation of a resist pattern. Consequently, when the polymer is used within a positive resist composition, the alkali solubility of the exposed portions improves, which contributes to a favorable improvement in the resolution.

The structural unit (a3) can be appropriately selected from the multitude of structural units proposed for resins for use within ArF excimer laser resist compositions.

For example, structural units which contain a hydroxyl group-containing polycyclic group and are derived from a (meth)acrylate ester are preferred. The polycyclic group can be appropriately selected from the same multitude of polycyclic groups described above in relation to the structural unit (a1).

Specifically, as the structural unit (a3), hydroxyl group-containing adamantyl groups (in which the number of hydroxyl groups is preferably from 1 to 3, and most preferably 1), or carboxyl group-containing tetracyclododecanyl groups (in which the number of carboxyl groups is preferably from 1 to 2, and most preferably 1) can be favorably used.

Even more specifically, using a structural unit represented by the aforementioned general formula (IV) as the structural unit (a3) increases the dry etching resistance and improves the verticalness of the pattern cross-sectional shape when the polymer is used within a positive resist composition, and is consequently preferred.

Furthermore, using a structural unit represented by the aforementioned general formula (V) as the unit (a3) also increases the dry etching resistance and improves the verticalness of the pattern cross-sectional shape when the polymer is used within a positive resist composition, and is consequently preferred.

In the general formula (V), the group —COOH may be bonded to either position 3 or 4 of the tetracyclododecanyl group shown in the formula, although a mixture of both isomers results, and so the bonding position cannot be further specified.

Furthermore, the carboxyl group residue of the (meth)acrylate structural unit may be bonded to either position 8 or 9 of the tetracyclododecanyl group, although similarly, a mixture of both isomers results, and so the bonding position cannot be further specified.

The structural unit (a3) typically accounts for 10 to 50 mol %, and preferably from 10 to 40 mol %, of the combined total of all the structural units that constitute the polymer. By ensuring the quantity exceeds the lower limit of this range, the improvement in the resolution becomes more significant, but if the quantity exceeds the upper limit of the above range, then there is a danger that problems may arise in terms of achieving a favorable balance with the other structural units.

Other Structural Units

In addition to the structural units (a1) to (a3), this polymer may also include other structural units.

Examples of these other structural units include lactone-containing structural units (a4) different from the structural unit (a1), and other structural units (a5) different from the structural units (a1) through (a4).

Structural Unit (a4)

As described above, when a lactone functional group is used within a positive resist composition, the lactone is effective in improving the adhesion between the resist film and the substrate, and increasing the hydrophilicity relative to the developing solution, and in order to maximize these effects, a lactone-containing structural unit (a4) that is different from the structural unit (a1) can also be used.

As the unit (a4), structural units which contain a lactone-containing monocyclic or polycyclic group and are also derived from a (meth)acrylate ester are preferred.

Examples of lactone-containing monocyclic groups include groups in which one hydrogen atom has been removed from γ-butyrolactone.

Examples of lactone-containing polycyclic groups include groups in which one hydrogen atom has been removed from one of the lactone-containing bicycloalkanes of the structural formulas shown below.

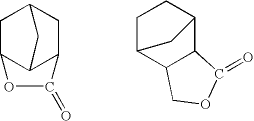

In addition, the lactone-containing monocyclic or polycyclic group is preferably one or more groups selected from the general formulas shown below.

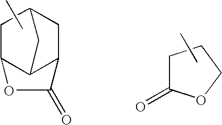

More specifically, structural units derived from a (meth)acrylate ester containing a lactone-containing monocycloalkyl group or bicycloalkyl group, as represented by the structural formulas shown below, are particularly preferred. 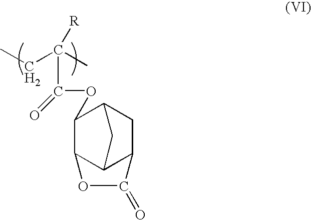
(wherein, R is as defined above) 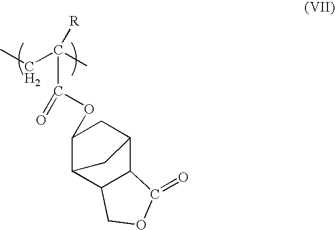
(wherein, R is as defined above) 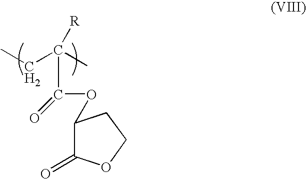
(wherein, R is as defined above)

Of these units, γ-butyrolactone esters of (meth)acrylic acid with an ester linkage at the α carbon atom, or norbomane lactone esters are particularly preferred in terms of industrial availability.

The structural unit (a4) typically accounts for 0 to 60 mol %, and preferably from 20 to 50 mol %, of the combined total of all the structural units that constitute the polymer. By ensuring the quantity falls within the above range, the resolution and adhesion of the composition to the substrate can be improved.

Structural Unit (a5)

There are no particular restrictions on the structural unit (a5), provided it is a different structural unit that cannot be classified as any of the above structural units (a1) through (a4). In other words, any structural unit that contains no acid dissociable, dissolution inhibiting groups, lactones, or hydroxyl groups is suitable. For example, structural units containing an aliphatic polycyclic group and derived from a (meth)acrylate ester are preferred. If this type of structural unit is used, then when the polymer is used within a positive resist composition, the composition exhibits superior resolution for isolated patterns through to semi-dense patterns (line and space patterns in which for a line width of 1, the space width is from 1.2 to 2), which is preferred.

Suitable examples of the aliphatic polycyclic group include similar groups to those listed in the above description for the structural unit (a1), and any of the multitude of materials conventionally used for ArF positive resist materials can be used.

From the viewpoint of industrial availability, one or more groups selected from amongst tricyclodecanyl groups, adamantyl groups, and tetracyclododecanyl groups is preferred.

Specific examples of the structural unit (a5) are shown below by the general formulas (IX) to (XI). 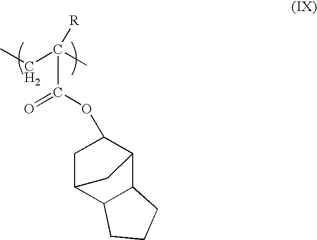
(wherein, R represents a hydrogen atom or a methyl group) 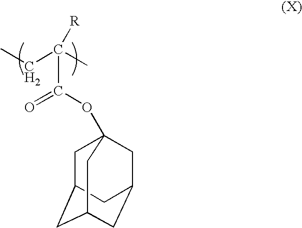
(wherein, R represents a hydrogen atom or a methyl group) 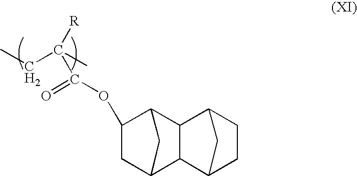
(wherein, R represents a hydrogen atom or a methyl group)

If the structural unit (a5) accounts for 0 to 25 mol %, and preferably from 1 to 20 mol %, of the combined total of all the structural units that constitute the polymer, then the polymer exhibits superior resolution for isolated patterns through to semi-dense patterns, which is desirable.

In this polymer, the structural units other than the structural unit (a1) can be selected in accordance with factors such as the intended application, although polymers that include the structural unit (a1) and the structural unit (a2) are preferred, and terpolymers that also contain a structural unit (a3) are also very desirable.

In the case of a binary polymer containing structural units (a1) and (a2), setting the quantity of the structural unit (a1) from 30 to 60 mol %, and preferably from 20 to 50 mol %, of the total of all the structural units, and the quantity of the structural unit (a2) from 20 to 60 mol %, and preferably from 20 to 50 mol %, yields a superior pattern shape and superior dry etching resistance, and is consequently preferred.

In addition, in the case of a terpolymer that also contains a structural unit (a3), setting the quantity of the structural unit (a1) from 30 to 60 mol %, and preferably from 30 to 50 mol %, of the total of all the structural units, the quantity of the structural unit (a2) from 20 to 60 mol %, and preferably from 20 to 50 mol %, of the total of all the structural units, and the quantity of the structural unit (a3) to 10 to 50 mol %, and preferably from 10 to 40 mol %, of the total of all the structural units, enables a superior resolution to be achieved, and is consequently preferred.

Within the structural units contained within the component (A), larger quantities of acrylate structural units tend to cause a lowering of the glass transition temperature of the component (A), whereas larger quantities of methacrylate structural units tend to cause an increase in the glass transition temperature of the component (A).

As a result, when heating treatments such as the PAB treatment and PEB treatment are conducted on the positive resist composition during the process for forming a resist pattern in the manner described below, compositions in which the quantity of methacrylate units is large can be subjected to higher heating temperatures, meaning the sensitivity of the positive resist composition tends to improve.

On the other hand, if the quantity of acrylate structural units is large, then the effect of the composition in suppressing surface roughness following etching tends to strengthen.

Accordingly, the ratio between acrylate structural units and methacrylate structural units is preferably selected in accordance with the intended application, taking due consideration of factors such as the required levels of sensitivity and surface roughness and the like.

Although there are no particular restrictions on the weight average molecular weight of the polymer, the value is preferably within a range from 5,000 to 30,000, and even more preferably from 8,000 to 20,000. If the weight average molecular weight is larger than this range, then when used as a positive resist composition, the solubility of the polymer within the resist solvent deteriorates, whereas if the value is smaller than the above range, there is a danger of a deterioration in the cross-sectional shape of the resist pattern.

This polymer can be produced easily by a conventional radical polymerization or the like of the monomers [(meth)acrylates] corresponding with the aforementioned structural units (a1) through (a5), using a radical polymerization initiator such as azobisisobutyronitrile (AIBN).

The monomer corresponding with the structural unit (a1) can be obtained, for example, by subjecting (meth)acrylic acid and a spirolactone derivative containing a double bond to an addition reaction using the known method disclosed in the patent reference 9. The spirolactone derivative has a double bond between the carbon atom to which the carboxyl group of the (meth)acrylic acid bonds, and the neighboring carbon atom. In other words, this monomer is obtained by an addition reaction of the (meth)acrylic acid to the double bond of the spirolactone derivative.

The monomers corresponding with the structural units (a2) through (a5) are readily available as commercial products.

[Positive Resist Composition]

Component (A)

As the component (A), any polymer that includes the aforementioned structural units (a1) as an essential component, and exhibits increased solubility in alkali under the action of acid can be used without any particular restrictions.

Component (B)

As the component (B), a compound appropriately selected from known materials used as acid generators in conventional chemically amplified resists can be used.

Examples of suitable compounds for this acid generator include onium salts such as diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate, and triphenylsulfonium nonafluorobutanesulfonate. Of these compounds, onium salts containing a fluorinated alkylsulfonate ion as the anion are preferred.

The component (B) can be used either alone, or in combinations of two or more different compounds.

The blend quantity of the component (B) is typically within a range from 0.5 to 30 parts by weight, and preferably from 1 to 10 parts by weight, per 100 parts by weight of the component (A). Ensuring the quantity is at least 0.5 parts by weight enables pattern formation to proceed satisfactorily, whereas restricting the quantity to no more than 30 parts by weight tends to enable a more uniform solution to be obtained, thus improving the storage stability.

Component (C)

A positive resist composition can be produced by dissolving the aforementioned component (A) and the component (B), together with any optional components (D) described below, preferably in the component (C). There are no particular restrictions on the quantity of the component (C) used within the positive resist composition, which can be set to ensure a concentration that enables favorable application of the positive resist composition to the surface of a substrate or the like.

The component (C) may be any solvent capable of dissolving the component (A) and the component (B) to generate a uniform solution, and one or more solvents selected from known materials used as the solvents for conventional chemically amplified resists can be used.

Specific examples of the solvent include ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents can be used alone, or as a mixed solvent of two or more different solvents. There are no particular restrictions on the quantity used of the solvent, which should be sufficient to generate a concentration that enables favorable application of the composition to a substrate or the like. For example, the solid fraction that constitutes the positive resist composition of the present invention (the fraction that remains as a solid when the solvent (C) is removed) is typically within a range from 2 to 20% by weight, and preferably from 3 to 15% by weight.

In particular, mixed solvents of propylene glycol monomethyl ether acetate (PGMEA) and a polar solvent containing a hydroxyl group or a lactone such as propylene glycol monomethyl ether (PGME), ethyl lactate (EL) or γ-butyrolactone improve the storage stability of the positive resist composition, and are consequently preferred.

In those cases where EL is added, the weight ratio of PGMEA:EL is preferably within a range from 6:4 to 4:6.

In those cases where PGME is added, the weight ratio of PGMEA:PGME is typically within a range from 8:2 to 2:8, and preferably from 8:2 to 5:5.

Furthermore, mixed solvents containing at least one of PGMEA and ethyl lactate, together with γ-butyrolactone, are also preferred as the organic solvent (C). In such cases, the weight ratio of the former and latter components in the mixed solvent is preferably within a range from 70:30 to 95:5.

Component (D)

In the positive resist composition, in order to improve properties such as the resist pattern shape and the post exposure stability of the latent image formed by the pattern-wise exposure of the resist layer, an amine, and preferably a secondary lower aliphatic amine or a tertiary lower aliphatic amine, can also be added as an optional component (D).

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine, triethanolamine and triisopropanolamine, and alkanolamines such as triethanolamine are particularly preferred.

These amines may be used alone, or in combinations of two or more different compounds.

This amine is typically added in a quantity within a range from 0.01 to 2% by weight relative to 100% by weight of the component (A).

(E) Organic Carboxylic Acid, or Phosphorus Oxo Acid or Derivative Thereof

In the positive resist composition, in order to improve the resist pattern shape and the post exposure stability of the latent image formed by the pattern-wise exposure of the resist layer in a similar manner to the aforementioned component (D), an organic carboxylic acid, or a phosphorus oxo acid or derivative thereof can also be added as another optional component (E). The component (D) and the component (E) can be used in combination, or either one may also be used alone.

Examples of suitable organic carboxylic acids include malonic acid, citric acid, malic acid, succinic acid, benzoic acid, and salicylic acid.

Examples of suitable phosphorus oxo acids or derivatives thereof include phosphoric acid or derivatives thereof such as esters, including phosphoric acid, di-n-butyl phosphate and diphenyl phosphate; phosphonic acid or derivatives thereof such as esters, including phosphonic acid, dimethyl phosphonate, di-n-butyl phosphonate, phenylphosphonic acid, diphenyl phosphonate, and dibenzyl phosphonate; and phosphinic acid or derivatives thereof such as esters, including phosphinic acid and phenylphosphinic acid, and of these, phosphonic acid is particularly preferred.

The component (E) is typically used in a quantity within a range from 0.01 to 5.0 parts by weight per 100 parts by weight of the component (A).

Miscible additives can also be added to the positive resist composition according to need, including additive resins for improving the properties of the resist film, surfactants for improving the ease of application, dissolution inhibitors, plasticizers, stabilizers, colorants and halation prevention agents.

This positive resist composition exhibits excellent transparency relative to wavelengths of 200 nm or shorter, and is consequently very useful as the positive resist composition for an ArF excimer laser, but it is also useful as a resist for even shorter wavelength sources such as F₂ excimer lasers, and other radiation such as EUV (extreme ultraviolet), VUV (vacuum ultraviolet), electron beams, X-rays, and soft X-rays.

This positive resist composition can suppress the occurrence of surface roughness such as line edge roughness that occurs within a resist pattern, either following etching or following developing, or preferably following both processes. The post-etching surface roughness suppression effect is particularly powerful.

This positive resist composition also exhibits favorable resolution. In recent years, the design rules prescribed for semiconductor element production have continued to become more stringent, and a resolution of no more than 150 nm, and in the vicinity of 100 nm is now required, and this positive resist composition can also be used for such applications.

Furthermore, this positive resist composition also provides a broad depth of focus, which is preferred in terms of factors such as ease of production.

[Method for Forming Resist Pattern (Production Method)]

A method for forming a resist pattern according to the present invention can be conducted, for example, in the manner described below.

Namely, a positive resist composition described above is first applied to the surface of a substrate such as a silicon wafer using a spinner or the like, a prebake (PAB treatment) is conducted under temperature conditions of 80 to 150° C. for 40 to 120 seconds, and preferably for 60 to 90 seconds, and following selective exposure of the applied resist with an ArF exposure apparatus or the like, by irradiating ArF excimer laser light through a desired mask pattern, a PEB (post exposure baking) treatment is conducted under temperature conditions of 80 to 150° C. for 40 to 120 seconds, and preferably for 60 to 90 seconds. Subsequently, developing is conducted using an alkali developing solution such as a 0.1 to 10% by weight aqueous solution of tetramethylammonium hydroxide. In this manner, a resist pattern that is faithful to the mask pattern can be obtained.

An organic or inorganic anti-reflective film may also be provided between the substrate and the applied layer of the resist composition.

### EXAMPLES

As follows is a more detailed description of the present invention, based on a series of examples.

### Example 1

The components (A) to (D) described below were mixed together and dissolved to prepare a positive resist composition.
Component (A): 100 parts by weight of a copolymer (weight average molecular weight: 10,000) produced by copolymerization of the following monomers: 40 mol % of 2-methyl-2-adamantyl methacrylate (which corresponds with the structural unit (a2), and generates a structural unit of the general formula (I) wherein R¹ is a methyl group and R is a methyl group), 40 mol % of a mixture of the four methacrylates represented by the general formulas (1)′ to (4)′ shown below, wherein R is a methyl group in each case, 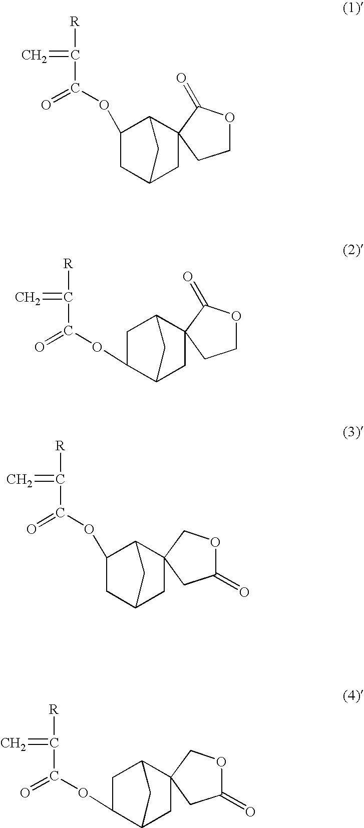
(wherein, R is a methyl group or a hydrogen atom), and 20 mol % of 3-hydroxy-1-adamantyl acrylate (which corresponds with the structural unit (a3), and generates a structural unit of the general formula (IV) wherein R is a hydrogen atom).
Component (B): 2.5 parts by weight of triphenylsulfonium nonafluorobutanesulfonate.
Component (C): a mixed solvent containing 450 parts by weight of PGMEA and 300 parts by weight of EL.
Component (D): 0.1 parts by weight of triethanolamine.

Subsequently, this positive type resist composition was applied to the surface of a silicon wafer using a spinner, prebaked (PAB treatment) for 60 seconds at 130° C. on a hotplate, and dried to form a resist layer with a film thickness of 350 nm.

This film was then selectively irradiated with an ArF excimer laser (193 nm) through a mask pattern, using an ArF exposure apparatus NSR-S302A (manufactured by Nikon Corporation, NA (numerical aperture)=0.60, σ=0.75).

The film was then subjected to PEB treatment at 120° C. for 60 seconds, subsequently subjected to puddle development for 30 seconds at 23° C. in a 2.38% by weight aqueous solution of tetramethylammonium hydroxide, and was then washed for 20 seconds with water, and dried.

As a result, a 130 nm Line and Space Pattern (1:1) was formed with good shape. The sensitivity was 15 mJ/cm².

The depth of focus for the 130 nm Line and Space Pattern (1:1) was 500 nm.

Furthermore, when the 3σ value was determined, which is a measure of the line edge roughness of Line and Space Pattern, the result was 5.2 nm.

The 3σ value is determined by measuring the resist pattern width of the sample at 32 positions using a measuring SEM (S-9220, a brand name, manufactured by Hitachi, Ltd.), and calculating the value (3σ) of 3 times the standard deviation (a) from these measurement results. The smaller this 3σ value is, the lower the level of roughness, indicating a resist pattern with a uniform width.

Furthermore, in order to evaluate the surface roughness following etching, an unpatterned resist film was prepared (by applying the positive type resist composition to a substrate, and conducting exposure without using a mask pattern), and subsequently etched under the following conditions.

Etching Conditions. Gas: a mixed gas containing tetrafluoromethane: 30 sccm, trifluoromethane: 30 sccm, and helium: 100 sccm; pressure: 0.3 Torr; RF (Ratio frequency): frequency: 400 kHz, output: 600 W; temperature: 20° C.; time: 2 minutes; etching apparatus: TCE-7612X (a brand name, manufactured by Tokyo Ohka Kogyo Co., Ltd.).

The reason for performing the evaluation using an unpatterned resist film is that this enables surface roughness to be measured more easily.

The surface following this etching was numericalized with an AFM (Atomic Force Microscope), and when the Rms value (root mean square surface roughness) was then determined, which is a value representing the surface roughness, the result was 6.0 nm.

### Example 2

With the exception of replacing the component (A) from the example 1 with a terpolymer (weight average molecular weight: 10,000) in which the 2-methyl-2-adamantyl methacrylate was replaced with 2-ethyl-2-adamantyl methacrylate (which generates a structural unit of the general formula (I) wherein R¹ is an ethyl group and R is a methyl group), and the mixture of the monomers represented by the general formulas (1)′ to (4)′ was replaced with a mixture of the corresponding acrylates in which R is a hydrogen atom, a positive resist composition was produced and evaluated in the same manner as the example 1. The conditions for the PAB treatment and the PEB treatment were 110° C. for 60 seconds, and 100° C. for 60 seconds respectively.

As a result, a 130 nm Line and Space Pattern (1:1) was formed with good shape, and the depth of focus was 500 nm. The sensitivity was 18 mJ/cm². Determination of the 3σ value revealed a result of 4.2 nm.

The Rms value, measured in the same manner as the example 1, was 5.0 nm.

### Example 3

With the exceptions of replacing the component (A) from the example 2 with a terpolymer (weight average molecular weight: 10,000) in which the 2-ethyl-2-adamantyl methacrylate was replaced with 2-ethyl-2-adamantyl acrylate (which generates a structural unit of the general formula (I) wherein R¹ is an ethyl group and R is a hydrogen atom), and altering the conditions for the PAB treatment and the PEB treatment to 105° C. for 60 seconds, and 95° C. for 60 seconds respectively, a positive resist composition was produced and evaluated in the same manner as the example 2.

As a result, a 130 nm Line and Space Pattern (1:1) was formed with good shape, and the depth of focus was 500 nm. The sensitivity was 20 mJ/cm². Determination of the 3σ value revealed a result of 3.7 nm.

The Rms value, measured in the same manner as the example 1, was 1.6 nm.

### Example 4

With the exceptions of altering the component (A) as described below, and altering the conditions for the PAB treatment and the PEB treatment to 130° C. for 60 seconds, and 130° C. for 60 seconds respectively, a positive resist composition was produced and evaluated in the same manner as the example 1.
Component (A): 100 parts by weight of a copolymer (weight average molecular weight: 10,000) produced by copolymerization of: 50 mol % of an acrylate monomer represented by a general formula (XII) shown below (which corresponds with the structural unit (a2)), 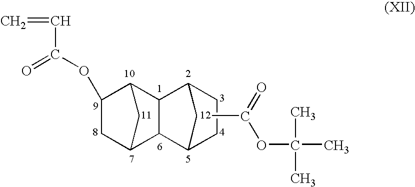
(wherein, the —COOC(CH₃)₃ group is bonded to the carbon atom labeled 3 or 4), 40 mol % of a mixture of the four acrylate monomers represented by the aforementioned general formulas (1)′ to (4)′ shown below, wherein R is a hydrogen atom in each case, and 10 mol % of an acrylate monomer represented by a general formula (XIII) shown below (which corresponds with the structural unit (a3)), 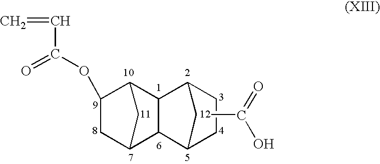
(wherein, the —COOH group is bonded to the carbon atom labeled 3 or 4).

As a result, a 130 nm Line and Space Pattern (1:1) was formed with good shape, and the depth of focus was 400 nm. The sensitivity was 40 mJ/cm². Determination of the 3σ value revealed a result of 3.7 nm.

The Rms value, measured in the same manner as the example 1, was 1.1 nm.

### Comparative Example 1

With the exception of altering the terpolymer of the component (A) from the example 1 by replacing the monomers represented by the general formulas (1)′ to (4)′ with α-gamma-butyrolactone methacrylate (which corresponds with the monomer unit of the general formula (VIII) wherein R is a methyl group), a positive resist composition was produced and evaluated in the same manner as the example 1.

As a result, a 130 nm Line and Space Pattern (1:1) was resolved with a reasonably favorable shape, although the pattern exhibited a slightly tapered shape. The depth of focus for the 130 nm L/S (1:1) was 300 nm, and the sensitivity was 15 mJ/cm². Determination of the 3σ value revealed a result of 5.0 nm.

The Rms value, measured in the same manner as the example 1, was 11.5 nm.

### Comparative Example 2

With the exceptions of altering the terpolymer of the component (A) from the example 2 by replacing the monomers represented by the general formulas (1)′ to (4)′ with α-gamma-butyrolactone methacrylate (which corresponds with the monomer unit of the general formula (VIII) wherein R is a methyl group), and altering the PAB treatment and PEB treatment conditions to 120° C. for 60 seconds, and 110° C. for 60 seconds respectively, a positive resist composition was produced and evaluated in the same manner as the example 2.

As a result, a 130 nm Line and Space Pattern (1:1) was resolved with a reasonably favorable shape, although the pattern exhibited a slightly tapered shape. The depth of focus for the 130 nm L/S (1:1) was 200 nm, and the sensitivity was 15 mJ/cm². Determination of the 3σ value revealed a result of 7.0 nm.

The Rms value, measured in the same manner as the example 1, was 13.5 nm.

From these results it is clear that in the examples according to the present invention, the Rms value was small in each case, confirming that the occurrence of surface roughness following etching can be suppressed. Furthermore, the LER value also tended to be comparatively smaller, indicating that the surface roughness of the resist pattern following alkali developing also tended to be suppressed.

In addition to these characteristics, it is also clear that the resist pattern shape was favorable, the sensitivity value tended to be high, and the resolution was also favorable. The depth of focus (DOF) was also large.

In the examples 1 and 2, the component (A) was a copolymer containing acrylate structural units and methacrylate structural units, and the glass transition temperature was high, and consequently, the temperatures for the PAB treatment and PEB treatment were able to be increased, enabling a higher level of sensitivity to be obtained. In the example 3, the component (A) contained only acrylate structural units, meaning that compared with the example 2, the glass transition temperature was lower, and the sensitivity was marginally lower, but the effect of the composition in suppressing surface roughness following etching was particularly favorable.

### INDUSTRIAL APPLICABILITY

As described above, a positive resist composition and a method for forming a resist pattern according to the present invention are capable of suppressing the surface roughness that occurs within a resist pattern, either following etching or following developing, or preferably following both processes. Accordingly, the present invention is extremely useful industrially.

1. A polymer comprising at least one structural unit (a1) containing a lactone represented by one of general formulas (1) through (4) shown below: 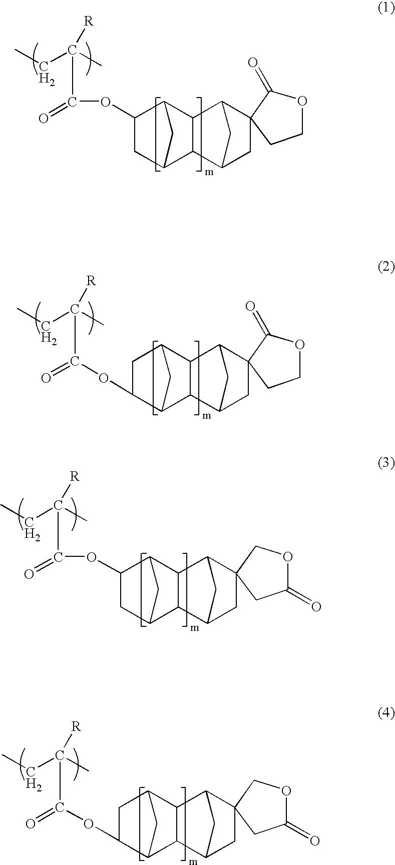
(wherein, in said formulas (1) to (4), R represents a hydrogen atom or a methyl group, and m is either 0 or 1).

2. A polymer according to claim 1, wherein said structural unit (a1) accounts for 30 to 60 mol % of a combined total of all structural units.

3. A polymer according to claim 1, further comprising a structural unit (a2), which contains an acid dissociable, dissolution inhibiting group, and is derived from a (meth)acrylate ester.

4. A polymer according to claim 3, wherein said structural unit (a2) is at least one unit selected from a group consisting of general formulas (I), (II), and (III) shown below: 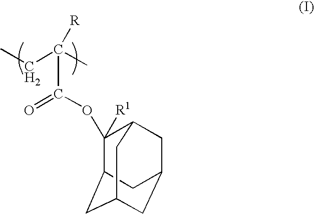
(wherein, R represents a hydrogen atom or a methyl group, and R¹ represents a lower alkyl group) 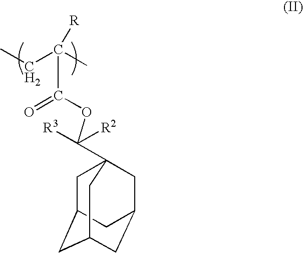
(wherein, R represents a hydrogen atom or a methyl group, and R² and R³ each represent, independently, a lower alkyl group) 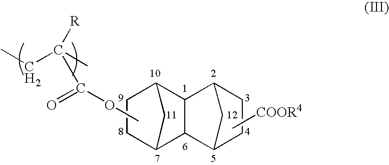
(wherein, R represents a hydrogen atom or a methyl group, and R⁴ represents a tertiary alkyl group).

5. A polymer according to claim 3, wherein said structural unit (a2) accounts for 20 to 60 mol % of a combined total of all structural units.

6. A polymer according to claim 1, further comprising a structural unit (a3), which contains a hydroxyl group and is derived from a (meth)acrylate ester.

7. A polymer according to claim 6, wherein said structural unit (a3) is one or two units selected from a group consisting of general formulas (IV) and (V) shown below: 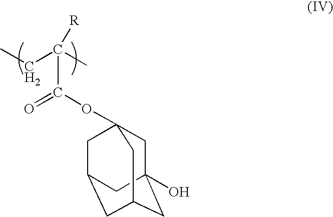
(wherein, R represents a hydrogen atom or a methyl group) 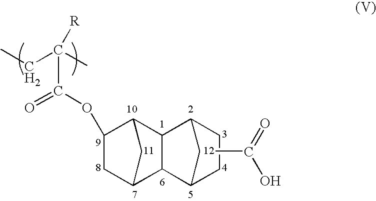
(wherein, R represents a hydrogen atom or a methyl group).

8. A polymer according to claim 6, wherein said structural unit (a3) accounts for 10 to 50 mol % of a combined total of all structural units.

9. A polymer according to claim 1, wherein said polymer exhibits increased alkali solubility under action of acid, and is used within a positive resist composition.

10. A positive resist composition, comprising a resin component (A), an acid generator component (B) that generates acid on exposure, and an organic solvent (C), wherein
said component (A) comprises a polymer according to claim 9.

11. A positive resist composition according to claim 10, wherein said component (B) is an onium salt with a fluorinated alkylsulfonate ion as an anion.

12. A positive resist composition according to claim 10, wherein said component (C) is a mixed solvent of propylene glycol monomethyl ether acetate and a polar solvent.

13. A positive resist composition according to claim 12, wherein said polar solvent is ethyl lactate.

14. A positive resist composition according to claim 10, further comprising an amine (D).

15. A method for forming a resist pattern, comprising the steps of applying a positive resist composition according to any one of claim 10 through claim 14 to a substrate, conducting a prebake, performing selective exposure, conducting PEB (post exposure baking), and performing alkali developing to form a resist pattern.
